(19) United States
(12) Patent Application Publication
(10) Pub. No.: US 2015/0336206 A1
(43) Pub. Date: Nov. 26, 2015

(54) TOOL FOR PRODUCING A FRICTION-WELDED CONNECTION BETWEEN A WIRE AND A SUBSTRATE, HAVING A POCKET-SHAPED RECESS

(71) Applicant: HESSE GMBH, Paderborn (DE)

(72) Inventors: Michael BROEKELMANN, Delbrueck (DE); Hans-Juergen HESSE, Paderborn (DE)

(73) Assignee: Hesse GmbH, Paderborn (DE)

(21) Appl. No.: 14/652,929

(22) PCT Filed: Dec. 5, 2013
(86) PCT No.: PCT/DE2013/100406

§ 371 Date: Jun. 17, 2015

(30) Foreign Application Priority Data
Dec. 17, 2012 (DE) 10 2012 112 413.2

(51) Int. Cl. B23K 20/12; B23K 20/10

(52) U.S. Cl. CPC B23K 20/129; B23K 20/10; B23K 20/1205

(57) ABSTRACT

The invention relates to a tool (1) for producing a friction-welded connection between a wire and a substrate having a tool shaft (2, 3) extending in the direction of a longitudinal center axis of the tool, having a tool receptacle section (2) for fastening the tool to a tool receptacle of a friction-welding machine and having a tool tip (3) connecting to the tool shaft, wherein a face (5) of the tool (1) is allocated to the tool tip (3) and wherein, in order to receive the wire during friction-welding, there is a channel-shaped groove (7) extending in a transverse direction of the tool in the region of the face (5) which is delimited by a shell surface, which can contact the wire at least in sections during friction welding, wherein there is at least one pocket-shaped recess (11) on the shell surface such that a cross-section of the groove (7) is designed to flare in the region of the recesses (11) and there is a wall of the recess (11) set back opposite the shell surface.

The invention relates to a tool for producing a friction-welded connection between a wire and a substrate, having a tool shaft extending in the direction of a longitudinal center axis of the tool, having a tool-holding section for immobilizing the tool relative to a tool holder of a friction-welding machine, and having a tool tip adjoining the tool shaft, wherein the tool tip is associated with an end surface of the tool and, in order to hold the wire during the friction welding, a channel-shaped groove extending in a transverse direction of the tool is provided in the region of the end surface and is delimited by a lateral surface that can be placed against at least parts of the wire during the friction welding, and also relates to a device for friction welding wire, having a workpiece holder for immobilizing the substrate, having a tool head that is provided so that it is able to move in rotary and/or translatory fashion relative to the workpiece holder, with the tool head having a tool holder for detachably holding a tool and having a tool that can be immobilized in the tool holder.

The invention also relates to a method for producing a friction-welded connection between a wire and a substrate, in which a tool with a channel-shaped groove at the front is lowered in the direction of the substrate until a lateral surface of the groove rests against at least parts of the wire provided between the tool and the substrate, the tool is pressed against the substrate with a predetermined force that pre-deforms the wire and as a result of the pre-deformation of the wire, a form-locked engagement is produced between the tool and the wire, an ultrasound source is activated, and the tool is excited so that it executes ultrasonic vibrations; a tool tip of the tool equipped with the groove oscillates in the longitudinal direction of the wire and as a result of the vibrations, the friction-welded connection is produced between the substrate and the wire that is guided in the groove in a form-locked fashion.

In ultrasonic wire bonding, a wire is bonded to a substrate by means of a tool that is excited so that it executes ultrasonic vibrations, in particular ultrasonic bending vibrations. First, the tool is lowered in the direction of the substrate with a predetermined normal force and the wire resting in a transverse groove of the tool is pre-deformed so that a form-locked engagement is produced between the tool and the wire. As a result of the form-locked engagement, the ultrasonic vibration of the tool is transmitted to the wire, a relative movement between the wire and tool is prevented, and the wire is forced to execute a frictional movement on the substrate. In this regard, the form-locked engagement between the tool and wire is a necessary prerequisite for producing a friction-welded connection between the wire and substrate. The plastic pre-deformation of the wire as the tool is being lowered in the direction of the substrate is usually promoted by the shape of the transverse groove of the tool. In particular, V-shaped groove forms are known, which plastically deform the round surface of the wire in a reliable way and result in an effective form-locked engagement between the wire and the tool. The degree of the pre-deformation of the wire in this case particularly depends on the hardness of the wire and the normal force that is exerted as the tool is being lowered. The normal force is calculated in additive fashion from a bonding force exerted during touchdown and the first derivative with respect to time of the first derivative of the touchdown momentum. The touchdown momentum is calculated from the touchdown speed and the product of the moved masses, i.e. in particular the tool and the tool head.

In current practice, aluminum wires are usually processed using ultrasonic friction welding. Commercially available tools are designed for these wires. If instead of a wire made of aluminum, a wire made of a harder material, for example a copper wire, is processed with the commercially available tool, then because of the greater hardness of the wire, the normal force exerted as the tool is being lowered must be increased if the form-locked engagement between the wire and tool is to be achieved in the same or a similar way. The greater normal force, however, can result in damage to or destruction of the substrate or of the chip that is to be processed. In this regard, it is not easily possible to use identical tools and to increase the normal force exerted on the wire when processing harder wires. Alternatively, it would be possible to shorten the groove for holding the wire during the bonding. With the same normal force, this then produces a greater surface pressure, which results in a sufficient form-locked engagement. Reducing the groove length, however, simultaneously reduces the connection area of the wire and substrate, thus exceeding the maximum current density and making it impossible to guarantee the mechanical strength of the connection.

When processing wires with a higher hardness, it is also known to use conventional tools and to profile or roughen the lateral surface of the transverse groove. For example, this is carried out by embedding diamond chips or by stamping a waffle pattern into the lateral surface, e.g. see DE 10 2007 046 021 B4 or US 2009/0127317 A1. Here, too, however, a conclusively satisfactory solution has not yet emerged.

The object of the present invention is to disclose a tool, a device, and a method for producing a friction-welded connection between a substrate and a wire with a high hardness, in particular a copper wire.

In order to attain the object, the invention is characterized in connection with the preamble to claim 1 in that at least one pocket-shaped recess is provided in the lateral surface such that a cross-section of the groove is embodied as widened in the region of the recesses and a wall of the recess is embodied as recessed relative to the lateral surface.

The particular advantage of the invention lies in the fact that by providing the pocket-shaped recess in the lateral surface of the transverse groove, the original form of the groove in terms of its cross-section and length can likewise be maintained and the effective area in the pre-deformation of the wire is reduced by the size of the recess. In this regard, with a constant normal force, the surface pressure increases so that a form-locked engagement between the tool and wire is safely and reliably produced, even with a hard wire. At the same time, the groove retains the original length so that the connection surface between the wire and substrate and therefore the current density and the mechanical strength of the connection are preserved.

The essence of the invention in this respect is to provide the lateral surfaces of a tool which is conventional in terms of its geometry and/or has been designed for processing aluminum wires and has a V-shaped transverse groove—with a pocket-shaped recess in an inner region of the lateral surface in order to widen the cross-section of the groove in the region of the recess. During the pre-deformation of the wire, because of the recesses, a contact between the wire and the tool is prevented in the region of the recesses. In this respect, the normal force acts on the wire distributed over a smaller effective area. The reduction of the area leads to an increase in the surface pressure and therefore to a more powerful plastic deformation of the wire in the contact region between the wire and the tool. The at least one recess is situated spaced apart from the two oblique surfaces (delimiting surfaces) of the tool tip that delimit the groove in the transverse direction.

Basically, the position of the recess in the groove can be freely selected. A spacing of the recess from the oblique surfaces delimiting the groove, however, must be established so that the shear forces exerted during the friction welding process can be absorbed by the tool.

According to a preferred embodiment of the invention, the recess extends from the end surface of the tool toward a bottom of the groove. It is thus advantageously possible to produce the recess in a particularly simple, inexpensive, and precise fashion. The reproducibility is high. In the end, this ensures that the tools can be prepared inexpensively and ensures that friction-welded connections produced with tools of the same type have reproducible electrical and mechanical properties.

According to a modification of the invention, the pocket-shaped recess can be embodied as symmetrical relative to a transverse plane of the tool, which contains the longitudinal center axis of the tool and extends in the direction of the groove, and/or relative to a normal plane of the tool, which contains the longitudinal center axis of the tool and extends perpendicular to the transverse plane of the tool.

According to a modification of the invention, a groove depth, which is defined by distance from the end surface of the tool to the bottom of the groove, is greater than a recess depth measured in the direction of the longitudinal center axis of the tool, and/or the groove depth corresponds to the recess depth. In this respect, the recess does not extend into the tool beyond the bottom of the groove. The mechanical strength of the tool is preserved. At the same time, the vibrational properties of the tool are not influenced or are only influenced slightly so that the ultrasonic vibration in the tool can develop in the usual way.

According to a modification of the invention, a length of the groove measured in the transverse direction of the tool can be at least twice as great as a maximum transverse dimension of the recess likewise measured in the transverse direction. This advantageously limits the magnitude of the surface pressure and the size of the effective lateral surface. In particular, with a maximum, constant transverse dimension of the recess, it is possible to halve the lateral surface and as a result of this, double the surface pressure. If the hardness of the wire that is to be processed is greater than that of an aluminum wire by a factor of 2, then with the present tool, it is possible to achieve a sufficient pre-deformation and a reliable form-locked engagement between the wire and the tool without increasing the normal force and without the risk of damage to the substrate or chip. For example, the hardness of copper is greater than that of aluminum by a factor of approximately 1.8. In this respect, the tool according to the invention can be used to reliably attach a copper wire to the substrate by means of friction welding without changing the normal forces that act on the wire and substrate.

According to a modification of the invention, the recess depth and a maximum perpendicular dimension of the recess, which is determined by a depth dimension of the recess in the direction of a plumb bob placed on the lateral surface, are established such that a contact between the wire and tool in the region of the recess does not occur during the first process step in which the tool is lowered in the direction of the substrate and the wire that is provided in the groove between the tool and the substrate is pre-deformed, whereas the wire does touch the wall of the recess when, after the lowering of the tool and after the pre-deformation of the wire, the friction-welded connection is produced by generating ultrasonic vibration. The time at which the wire contacts the wall of the recess depends on the geometry of the wall. In this regard, the wall can be embodied as a free-form surface. The duration of the contact of the wire with the wall of the recess can comprise any part of the processing time, in particular even 100%. This can be advantageously used on the one hand to increase the surface pressure during the lowering while a normal force remains constant. At the same time, the tool presses the wire against the substrate in the region of the recess after the pre-deformation and during the friction welding. In this respect, the wire is prevented from moving out of the way perpendicular to the bonding surface in the region of the recess. The quality of the friction-welded connection is improved in that the production of the connection is ensured in the entire contact area, thus preventing the occurrence of a defective friction-welded connection.

According to a modification of the invention, the groove has a V-shaped basic cross-section, which is widened out into a U-shaped cross-section in the region of the recess. Advantageously, a U-shaped cross-section can be easily produced. The use of a V-shaped basic cross-section makes it possible to reengineer a commercially available tool for processing aluminum wire to produce a tool for processing harder wires, e.g. for processing a copper wire. In this regard, the tool for processing hard wires can also be produced in small numbers in a comparatively inexpensive fashion.

According to a modification of the invention, a maximum width of the recess measured perpendicular to the transverse direction assumes its greatest value at the end surface of the tool. In particular, the recess then tapers in the direction of the groove bottom. This advantageously prevents the occurrence of an undercut in the region of the recess and prevents a straining of the deformed wire in the tool so that the tool can be lifted away from the wire without causing damage.

In order to attain the object, the invention, together with the preamble to claim 10, is characterized in that during the execution of the ultrasonic bending oscillation, an auxiliary contact surface, which does not touch the wire at the time when the ultrasound source is activated, comes to rest against the wire as a result of a further deformation of the wire and/or a further lowering of the tool in the direction of the substrate.

The particular advantage of the invention lies in the fact that the contacting of the auxiliary contact surface during the ultrasonic welding prevents the wire from moving out of the way perpendicular to the end surface of the tool or perpendicular to the connecting surface. This promotes the quality of the friction-welded connection. Both the electrical and mechanical properties of the connection benefit as a result.

For example, when a tool according to the invention is used for producing the friction-welded connection between the wire and the substrate, at least a part of the wall of the recess becomes an auxiliary contact surface. During the touchdown of the tool onto the substrate and the pre-deformation of the wire provided between the tool and the substrate, the wire specifically does not rest against the wall in order to ensure a sufficient surface pressure in the region of the groove. After a pre-deformation that is sufficient for the form-locked engagement is achieved and after the friction welding process is started, the wire is moved in its longitudinal direction relative to the substrate. The plastic deformation of the wire proceeds. During the friction welding process, the wire comes into contact with the wall of the recess. It is then no longer possible for the wire to move out of the way perpendicular to the welding plane.

According to a preferred embodiment of the invention, the tool is excited so that it executes ultrasonic vibrations for a processing time, with the wire touching the tool in the region of the auxiliary contact surface, at least for a partial processing time. The partial processing time is greater than 0%, preferably at least 50%, and at most 100% of the processing time. Advantageously, the quality of the friction-welded connection is improved by the contact between the wire and the tool in the region of the auxiliary contact surface. Since the contact in the region of the auxiliary contact surface prevents the wire from being able to move out of the way, the contact with the auxiliary contact surface must be produced as quickly as possible and be maintained for the remaining portion of the processing time. Nevertheless, in order to ensure a sufficient pre-deformation and the production of the form-locked engagement between the wire and tool, it is necessary to ensure that as the tool is being lowered and the wire is being pre-deformed, the surface pressure is sufficiently high and as a result, the wire does not rest against the tool in the region of the recesses.

Other advantages of the invention ensue from the remaining dependent claims.

Other advantages, features, and details of the invention ensue from the following description. The features mentioned in the claims and the specification can each be essential to the invention in and of themselves or in any combination with one another. Features and details that are described in connection with the tool according to the invention also apply with regard to the method or respective device according to the invention and vice versa. Consequently, reference can always be made back and forth between them with regard to the disclosure of individual aspects of the invention.

Exemplary embodiments of the invention will be explained in greater detail below in conjunction with the drawings.

In the drawings:

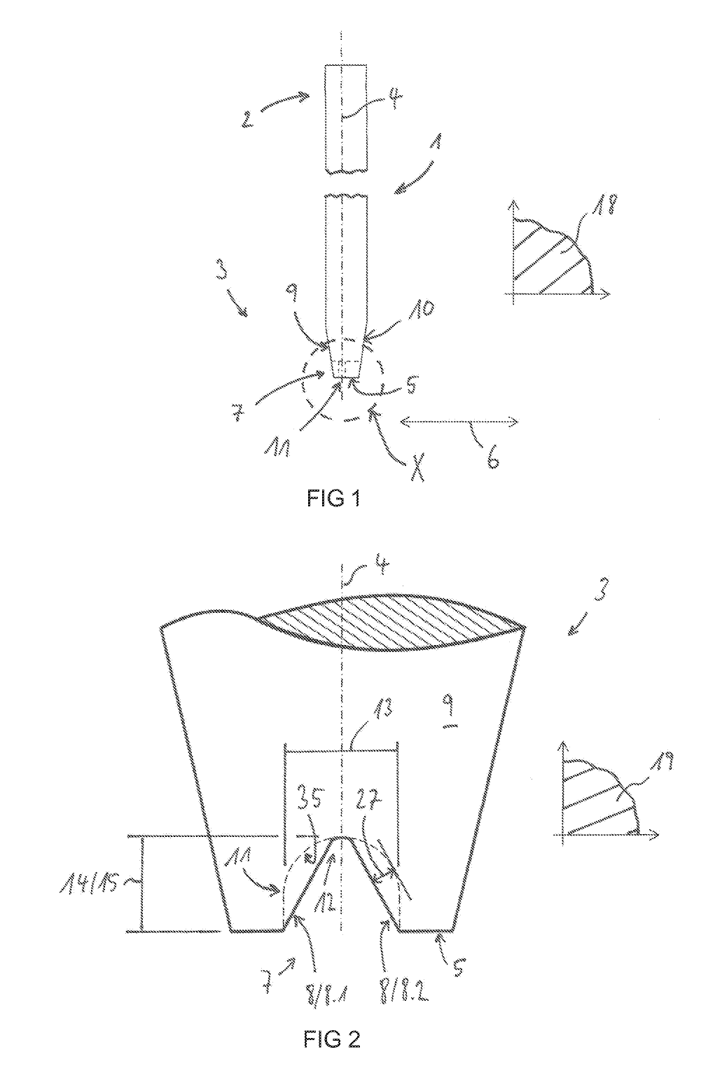

FIG. 1 shows a side view of a tool according to the invention for processing harder wires, having a tool shaft, a tool holder section, and a tool tip,

FIG. 2 is an enlarged depiction of the tool tip in a front view of the region X according to FIG. 1,

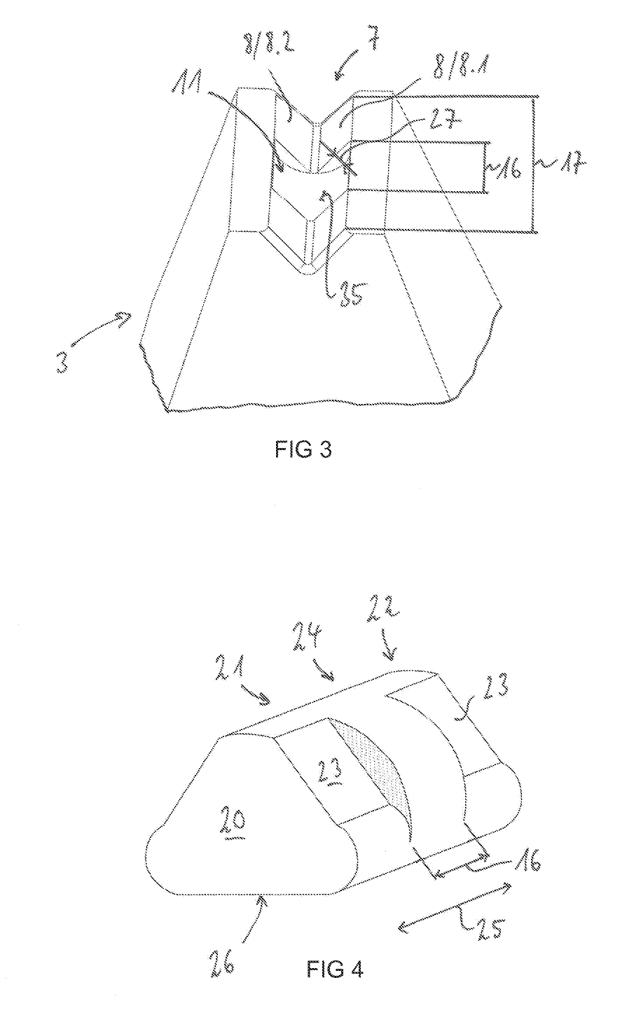

FIG. 3 is a perspective view of the tool tip with a U-shaped recess,

FIG. 4 shows a section of a wire that is deformed by means of the tool according to FIG. 1,

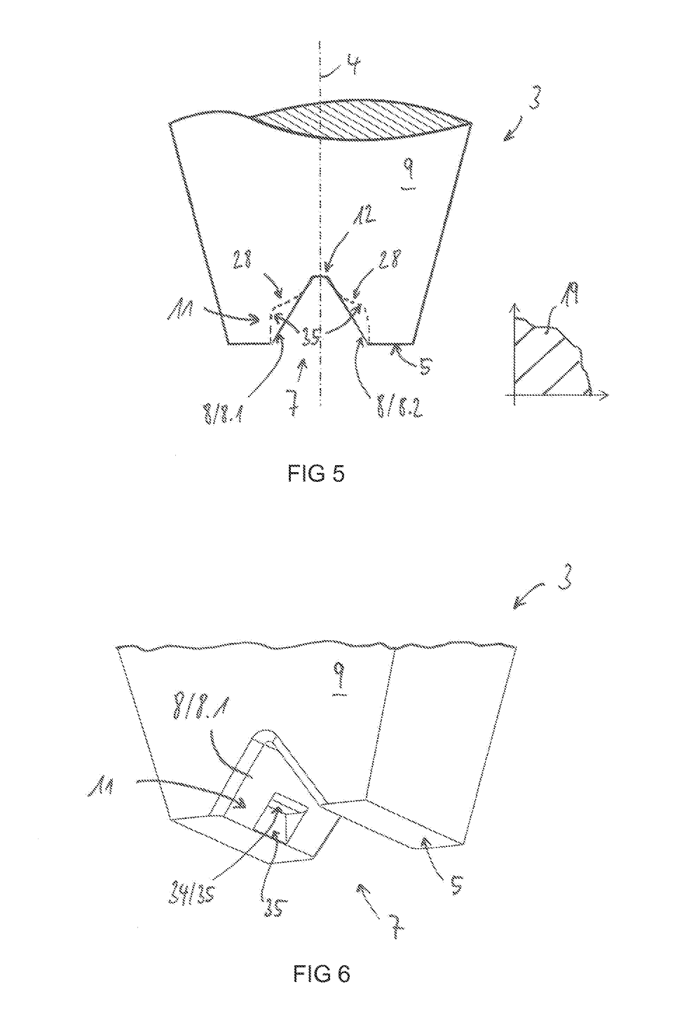

FIG. 5 shows a front view of the tool tip of an alternative embodiment of the tool according to the invention,

FIG. 6 shows a perspective view of the tool tip of the tool according to FIG. 5,

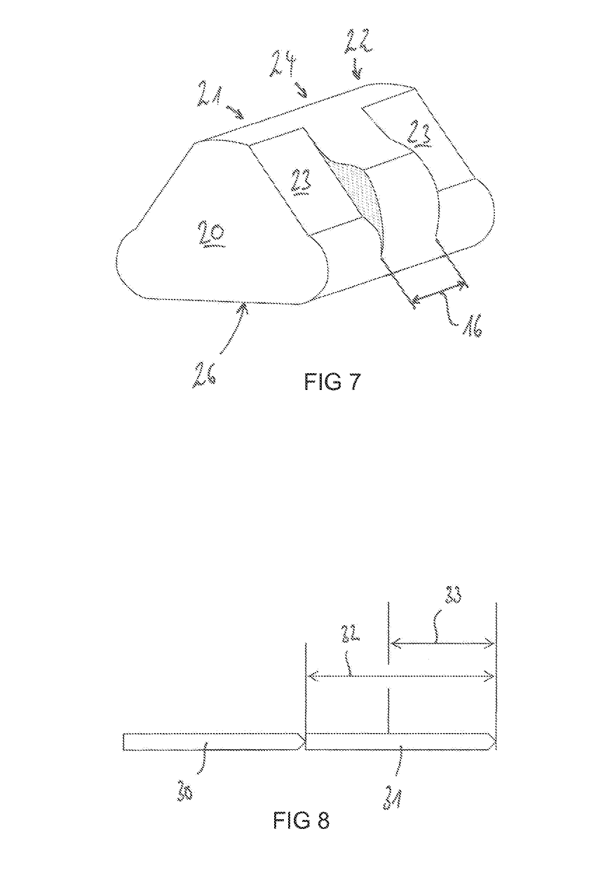

FIG. 7 shows a section of a wire that has been deformed by means of the tool according to FIG. 5, and

FIG. 8 shows a time sequence of a friction welding process according to the invention.

A tool according to the invention shown in FIGS. 1 through 3 includes a tool shaft 1 extending in a longitudinal axis 4 of the tool, a tool holder section 2 adjoining the tool shaft 1, and a tool tip 3, which adjoins the tool shaft 1 at the end oriented away from the tool holder section 2. The tool holder section 2 is embodied so that the tool can be inserted into and immobilized in a tool holder of a friction welding machine, in particular an automatic bonding machine. The tool is embodied as symmetrical relative to the longitudinal center axis 4 of the tool. In the region of the tool tip 3, the tool tapers in the direction of the longitudinal center axis 4 of the tool, with the tool tip 3 having its narrowest width in the region of an end surface 5.

For example, the tool according to the invention is used for producing a friction-welded connection between a wire 20 and a substrate or semiconductor chip. In order to hold the wire 20 during the friction welding, a channel-shaped groove 7 extending in a transverse direction 6 of the tool is embodied in the tool in the region of the end surface 5. In this case, the channel-shaped groove 7 is embodied as a V-shaped groove 7. A lateral surface 8 of the groove 7 is delimited by two flat partial lateral surfaces 8.1, 8.2 extending at an angle to each other.

Spaced apart from two oblique surfaces 9, 10 of the tool that delimit the groove 7, a pocket-shaped recess 11 is provided in an inner region of the groove 7. In the region of the recess 11, the V-shaped cross-section of the groove 7 (basic cross-section) is widened. The recess 11 has a U-shaped cross-section and is delimited by a wall 35 that is recessed relative to the lateral surface 8. The recess 11 extends from the end surface 5 of the tool tip 3 to a groove bottom 12, which connects the partial lateral surfaces 8.1, 8.2 that are lined up with each other. The recess 11 has its maximum width 13 in the region of the end surface 5 and tapers in the direction of the groove bottom 12. The maximum width 13 of the recess 11 in this case corresponds to a maximum width of the groove 7. Since the recess 11 extends exactly to the groove bottom 12, a groove depth 14 corresponds to a depth 15 of the recess 11 in the direction of the longitudinal center axis 4 of the tool.

The recess 11 has a constant transverse dimension 16 in the transverse direction 6 of the groove 7. The transverse dimension 16 of the recess 11 corresponds to approximately 40% of a length 17 of the groove 7 measured in the transverse direction 6. In this connection, the recess 11 is embodied as symmetrical to both a transverse plane 18 of the tool, which contains the longitudinal center axis 4 of the tool and extends in the direction of the groove 7, and to a normal plane 19 of the tool, which contains the longitudinal center axis 4 of the tool and extends perpendicular to the transverse plane 18 of the tool.

FIG. 4 shows a section of wire 20 that has been friction welded by means of the tool according to FIGS. 1 through 3. The wire 20 has an approximately triangular shape in a front region 21 and rear region 22. Two adjacent side surfaces 23 of the triangularly deformed wire section 20 in the front region 21 and rear region 22 have been formed by the V-shaped partial lateral surfaces 8.1, 8.2 of the tool. A third side of the triangularly deformed wire 20 defines the flat, current-carrying connecting surface 26 of the wire 20 and substrate.

Between the front region 21 and the rear region 22, there is a middle region 24 in which the wire 20 is deformed only in the region of the connecting surface 26 and otherwise remains non-deformed. During the production of the friction-welded connection, the recess 11 of the tool is associated with the middle region 24. In this middle region 24, the wire section 20 does not contact the tool and is therefore not deformed.

A length of the front region 21, the middle region 24, and the rear region 22 of the wire 20 measured in the wire longitudinal direction 25 corresponds to the length 17 of the groove 7 in the transverse direction 6. The length of the middle region 24 is determined by the transverse dimension 16 of the recess 11, while an equal length of the front region 21 and rear region 22 results from the length 17 of the groove 7 and the transverse dimension 16 of the recess 11.

In order to produce the friction-welded connection, the bonding tool is lowered in the direction of the substrate, with the tool tip 3 and the groove 7 at the front. During the lowering, the wire 20, which is associated with the groove 7 and is situated between the tool and the substrate, is acted on with a predetermined normal force and is deformed. The deformation produces a form-locked engagement between the wire 20 and the tool. During the lowering, the wire 20 initially touches the tool only in the region of the lateral surface 8. Since the groove 7 is embodied as widened in the region of the recess 11, no contact between the wire 20 and the tool occurs in the region of the recess 11. The wire 20 and the wall 35 of the recess 11 consequently do not contact each other. A surface pressure between the wire 20 and the tool is determined by the magnitude of the normal force and the size of the lateral surface 8, while remaining unaffected by a surface of the recess 11 oriented toward the wire 20. With a predetermined length 17 of the groove 7, the size of the recess 11 therefore determines the remaining size of the lateral surface 8.

Through the activation of an ultrasound source, the tool is excited so that it executes ultrasonic vibrations, in particular ultrasonic bending vibrations. Because of the form-locked engagement between the tool and the wire 20, the wire 20 executes ultrasonic vibrations in its longitudinal direction 25. The ultrasonic vibrations of the wire 20 result in a relative movement between the wire 20 and the substrate, which in cooperation with the effective normal force, results in the fact that a friction-welded connection is produced in the connecting surface 26. Finally, a size of the connecting surface 26 defines the maximum current and the mechanical strength of the friction-welded connection.

During the production of the friction-welded connection, the wire 20 in the region of the recess 11 has no contact with the tool or the wall 35 of the recess 11. Instead, the wire 20 rests against the tool only in the region of the lateral surface 8. In order to reliably prevent the contact between the wire 20 and the wall 35 of the recess 11, a perpendicular dimension 27 of the recess 11, which is defined as a depth dimension of the recess 11 in the direction of a plumb bob placed on the lateral surface 8, is selected as sufficiently large.

According to an alternative embodiment of the invention according to FIGS. 5 and 6, the tool has a recess 11 with a modified geometry in the region of the wall 35. Basically, the U-shaped cross-section of the recess 11 is retained in a region close to the end surface. The V-shaped cross-section of the groove 7, however, is retained in the vicinity of the groove bottom 12. In a connecting region 28, a boundary surface of the recess 11 extends essentially parallel to the end surface 5, with the transitions to the V shape and to the U shape being embodied through suitable transition geometries.

Components and component functions that are the same have been labeled with the same reference numerals.

FIG. 7 shows a section of the wire 20 that has been deformed by the tool according to FIGS. 5 and 6. It is clear that in an upper region oriented away from the connecting surface 26, the middle region 24 of the wire 20 approximates the V shape of the groove 7, which is likewise situated in the front region 21 and rear region 22 of the wire 20 and it is also clear that otherwise, the U shape returns. In order to achieve this, the recess 11 in the connecting region 28 is specifically embodied so that a contact between the tool and the wire 20 in the region of the recess 11 does not occur as the tool is being lowered in the direction of the substrate and during the pre-deformation of the wire 20. The wall 35 of the recess 11 does not touch the wire 20. In this regard, there is a comparatively high surface pressure in the region of the lateral surface 8, which ensures a sufficient pre-deformation of the hard wire 20 and the production of a form-locked engagement between the wire 20 and tool. At the same time, the geometry of the recess 11 and in particular of the connecting region 28 ensures that the contact between the wire 20 and the tool is produced at the end of the pre-deformation or in the course of the friction welding process and the wire 20 is also pressed against the substrate in the connecting region 28. At the same time, the wire 20 in the region of the connecting region 28 is prevented from moving out of the way laterally and/or perpendicular to the bonding surface (connecting surface 26).

For example, FIG. 8 shows the chronological progression of a method according to the invention for producing a friction-welded connection. In a first process step 30, the tool with the channel-shaped groove 7 at the front is lowered in the direction of the wire 20 until the lateral surface 8 of the groove 7 is resting against the wire 20 and deforms the wire 20 with a predetermined normal force. During this first process step 30, a form-locked engagement occurs between the wire 20 and the tool.

In a second process step 31, an ultrasound source is activated and the tool is excited so that it executes ultrasonic vibrations, in particular ultrasonic bending vibrations. Due to the form-locked engagement, the tool excites the wire 20 to execute vibrations in the longitudinal direction of the wire. As a result of the vibrations, a friction-welded connection is produced between the wire 20 and the substrate. The second process step 31 has a processing time 32 that is predetermined or that is established based on established process parameters.

At the end of the pre-deformation or in the course of the ultrasonic excitation, the contact is produced between the tool and the middle region 24 of the wire 20. In this case, a partial surface of the wall 35 of the recess 11, the so-called auxiliary contact surface 34, rests against the middle region 24 of the wire 20. The auxiliary contact surface 34 thus participates in the deformation process of the wire 20 to the same degree as the lateral surface 8 of the groove 7. In the end, the enlargement of the contact surface in the second process step 31 yields an improvement in the quality of the friction-welded connection between the wire 20 and the substrate. When establishing the geometry of the recess 11, it is thus necessary to ensure that in the first process step 30, the contact occurs only in the region of the lateral surface 8 and that at the beginning of the second process step 31 or as soon as possible after it begins, the auxiliary contact surfaces 34 are also brought into engagement. In the present example, the partial processing time 33 corresponds to approximately 60% of the processing time 32.

The examples of the tool shown illustrate the invention only by way of example. According to alternative embodiments of the invention that are not shown, the tool can, for example, be embodied asymmetrically, particularly in the region of the tool tip; in particular, the recess 11 can be embodied as asymmetrical with regard to the transverse plane 18 of the tool and/or with regard the normal plane 19 of the tool. Likewise, the transverse dimension 16 of the recess 11 in relation to the length 17 of the groove 7 can be selected according to the specific needs at hand. While a copper wire is harder than an aluminum wire by a factor of approximately 1.8 and as a result, the surface pressure should be increased by a corresponding degree, a material that is harder than aluminum and softer than copper can be friction welded with a tool that has a recess 11 with a smaller transverse dimension 16 than is shown here. Reducing the transverse dimension 16 enlarges the lateral surface 8 and reduces the surface pressure as a result. For example, a microstructure—in particular a waffle pattern or the like—can be provided in the region of the lateral surface 8.

The tool according to the invention can be inserted with the tool holder section 2 first into a tool holder of a device for friction welding wire to a substrate (friction welding machine). The tool holder is usually located on a tool head of the friction welding machine, which can be set into motion in a rotary and/or translatory fashion, while the substrate is immobilized by means of a workpiece holder of the friction welding machine. In particular, the tool can be used for bonding copper wire.

1. A tool for producing a friction-welded connection between a wire and a substrate, having a tool shaft extending in the direction of a longitudinal center axis of the tool, having a tool-holding section for immobilizing the tool relative to a tool holder of a friction-welding machine, and having a tool tip adjoining the tool shaft, wherein the tool tip is associated with an end surface of the tool and, in order to hold the wire during the friction welding, a channel-shaped groove extending in a transverse direction of the tool is provided in the region of the end surface and is delimited by a lateral surface that can be placed against at least parts of the wire during the friction welding, characterized in that at least one pocket-shaped recess is provided in the lateral surface such that a cross-section of the groove is embodied as widened in the region of the recesses and a wall of the recess is embodied as recessed relative to the lateral surface.

2. The tool according to claim 1, wherein the recess extends starting from the end surface of the tool in the direction of a bottom of the groove.

3. The tool according to claim 1, wherein the pocket-shaped recess is embodied as symmetrical relative to a transverse plane of the tool, which contains the longitudinal center axis of the tool and extends in the direction of the groove, and/or relative to a normal plane of the tool, which contains the longitudinal center axis of the tool and extends perpendicular to the transverse plane of the tool.

4. The tool according to claim 1, wherein a groove depth extending from the end surface to the bottom of the groove is greater than a recess depth measured in the direction der longitudinal center axis of the tool or in that the groove depth corresponds to the recess depth.

5. The tool according to claim 1, wherein a length of the groove measured in the transverse direction of the tool can be at least twice as great as a maximum transverse dimension of the recess likewise measured in the transverse direction.

6. The tool according to claim 1, wherein the transverse dimension of the recess is embodied as constant over the entire region of the recess.

7. The tool according to claim 1, wherein in the recess depth and a perpendicular dimension of the recess, which is determined by a depth dimension of the recess in the direction of a plumb bob placed on the lateral surface, are established such that a contact between the wire and tool in the region of the recess does not occur during a first process step in which the tool is lowered in the direction of the substrate and the wire that is provided in the groove between the tool and the substrate is pre-deformed and such that a contact between the wire and the tool does occur at the wall of the recess, whereas after the lowering of the tool and the pre-deformation of the wire in a second process step, the friction-welded connection with the substrate is produced by imparting an ultrasonic vibration via the tool to the wire in a longitudinal direction of the wire.

8. The tool according to claim 1, wherein the groove has a V-shaped basic cross-section, which has two flat partial lateral surfaces and is widened into a U-shaped cross-section in the region of the recess.

9. The tool according to claim 1, wherein a maximum width of the recess determined perpendicular to the transverse direction assumes its greatest value at the end surface of the tool and/or the maximum width of the recess corresponds to a maximum width of the groove.

10. A method for producing a friction-welded connection between a wire and a substrate, in which
a tool with a channel-shaped groove at the front is lowered in the direction of the substrate until a lateral surface of the groove rests against at least parts of the wire provided between the tool and the substrate,
the tool is pressed against the substrate with a predetermined force that pre-deforms the wire and as a result of the pre-deformation of the wire, a form-locked engagement is produced between the tool and the wire,
an ultrasound source is activated, and the tool is excited so that it executes ultrasonic vibrations and a tool tip of the tool equipped with the groove oscillates in the longitudinal direction of the wire and as a result of the vibrations, the friction-welded connection is produced,
characterized in that after the pre-deformation, at the beginning of or during the execution of the ultrasonic bending oscillation, an auxiliary contact surface, which does not touch the wire at the time when the ultrasound source is activated, comes into contact with the wire because of a further deformation of the wire and/or a further lowering of the tool in the direction of the substrate.

11. The method according to claim 10, in that wherein the tool is excited so that it executes ultrasonic vibrations for a processing time and during a partial processing time, the auxiliary contact surface rests against the wire, said partial processing time being greater than 0% of the processing time, preferably at least 50% and at most 100% of the processing time.

12. A device for friction welding wire, in particular copper wire, having a workpiece holder for immobilizing the substrate, having a tool head that is provided so that it is able to move in rotary and/or translatory fashion relative to the workpiece holder, with the tool head having a tool holder for detachably holding a tool, and having a tool that is immobilized in the tool holder, wherein the tool is embodied in the form of a tool according to claim 1.

13. A use of a tool according to claim 1 for friction welding copper wire.
